(19) United States
(12) Patent Application Publication
(10) Pub. No.: US 2011/0182206 A1
(43) Pub. Date: Jul. 28, 2011

(54) APPARATUS AND METHOD FOR ASSOCIATING A GATEWAY CONTROL SESSION WITH AN INTERNET PROTOCOL CONNECTIVITY ACCESS NETWORK (IP-CAN) SESSION

(75) Inventors: George Cherian, San Diego, CA (US); Jun Wang, La Jolla, CA (US); Haipeng Jin, Carlsbad, CA (US)

(73) Assignee: QUALCOMM Incorporated, San Diego, CA (US)

(21) Appl. No.: 12/986,075

(22) Filed: Jan. 6, 2011

Related U.S. Application Data
(60) Provisional application No. 61/298,133, filed on Jan. 25, 2010.

(51) Int. Cl. H04W 76/00

(52) U.S. Cl. 370/254

(57) ABSTRACT

An apparatus and method for associating a gateway control session with an Internet protocol connectivity access network (IP-CAN) session comprising receiving an IP address for a home agent/local mobility agent (HA/LMA); receiving an access terminal (AT) network access identifier (NAI); and associating the gateway control session with the IP-CAN session using the IP address and NAI. In one aspect, a policy charging and rules function (PCRF) receives an access point name (APN) information as: a Vendor Specific Option of either an IP control protocol (IPCP) or an IPv6 control protocol, a configuration option in a Vendor Specific Network Control Protocol, or a dynamic host configuration protocol extension for associating the sessions. The PCRF receives an AT IP address allocation and subsequently establishes the gateway control session to associate two sessions. The PCRF receives a correlation identifier in the gateway control session and in the IP-CAN session to associate two sessions.

### CLAIM OF PRIORITY UNDER 35 U.S.C. §119

The present Application for Patent claims priority to Provisional Application No. 61/298,133 entitled Method to Associate Gateway Control Session with IP-CAN Session for PCC filed Jan. 25, 2010, and assigned to the assignee hereof and hereby expressly incorporated by reference herein.

### FIELD

The present disclosure relates generally to apparatus and methods for Internet connectivity in a wireless communication system. More particularly, the present disclosure relates to associating a gateway control session with an Internet protocol connectivity access network (IP-CAN) session.

### BACKGROUND

In many telecommunication systems, communications networks are used to exchange messages among several interacting spatially-separated devices. The various types of networks may be classified in different aspects. In one example, the geographic scope of the network could be over a wide area, a metropolitan area, a local area, or a personal area, and the corresponding networks would be designated as wide area network (WAN), metropolitan area network (MAN), local area network (LAN), or personal area network (PAN). Networks also differ in the switching/routing technique used to interconnect the various network nodes and devices (e.g. circuit switching vs. packet switching), in the type of physical media employed for transmission (e.g. wired vs. wireless), or in the set of communication protocols used (e.g. Internet protocol suite, SONET (Synchronous Optical Networking), Ethernet, etc.).

One important characteristic of communications networks is the choice of wired or wireless media for the transmission of electrical signals among the constituents of the network. In the case of wired networks, tangible physical media such as copper wire, coaxial cable, fiber optic cable, etc. are employed to propagate guided electromagnetic waveforms which carry message traffic over a distance. Wired networks are a static form of communications networks and are typically favored for interconnection of fixed network elements or for bulk data transfer. For example, fiber optic cables are often the preferred transmission media for very high throughput transport applications over long distances between large network hubs, such as, bulk data transport across or between continents over the Earth's surface.

On the other hand, wireless networks are often preferred when the network elements are mobile with dynamic connectivity needs or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks have the distinct advantage of facilitating user mobility and rapid field deployment compared to fixed wired networks. However, usage of wireless propagation requires significant active resource management among the network users and high levels of mutual coordination and cooperation for compatible spectrum utilization.

### SUMMARY

Disclosed is an apparatus and method for associating a gateway control session with an Internet protocol connectivity access network (IP-CAN) session. According to one aspect, a method for associating a gateway control session with an Internet protocol connectivity access network (IP-CAN) session in a wireless network comprising receiving an IP address for a home agent/local mobility agent (HA/LMA); receiving a network access identifier (NAI) of an access terminal (AT); and associating the gateway control session with the Internet protocol connectivity access network (IP-CAN) session using the IP address and the NAI.

According to another aspect, a method for associating a gateway control session with an Internet protocol connectivity access network (IP-CAN) session in a wireless network comprising receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and associating the gateway control session with the Internet protocol connectivity access network (IP-CAN) session using the APN information.

According to another aspect, a method for associating a gateway control session with an Internet protocol connectivity access network (IP-CAN) session in a wireless network comprising receiving an access terminal (AT) IP address allocation; establishing the gateway control session after the IP address allocation is received; and associating the gateway control session with the IP-CAN session using the AT IP address allocation.

According to another aspect, a method for associating a gateway control session with an Internet protocol connectivity access network (IP-CAN) session in a wireless network comprising receiving a correlation identifier in the gateway control session; receiving the correlation identifier in the IP-CAN session; and associating the gateway control session with the IP-CAN session using the correlation identifier.

According to another aspect, a method for establishing a wireless connection comprising establishing a point-to-point protocol (PPP) link between an access terminal (AT) and a wireless network; establishing an Internet Protocol (IP) connection using the PPP link; and using the IP connection for sending at least one of the following: a network access identifier (NAI) of the AT, access point name (APN) information, IP address allocation of the AT, or a correlation identifier.

According to another aspect, an apparatus for associating a gateway control session with an Internet protocol connectivity access network (IP-CAN) session in a wireless network comprising means for receiving an IP address for a home agent/local mobility agent (HA/LMA); means for receiving a network access identifier (NAI) of an access terminal (AT); and means for associating the gateway control session with the Internet protocol connectivity access network (IP-CAN) session using the IP address and the NAI.

According to another aspect, an apparatus for associating a gateway control session with an Internet protocol connectivity access network (IP-CAN) session in a wireless network comprising means for receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and means for associating the gateway control session with the Internet protocol connectivity access network (IP-CAN) session using the APN information.

According to another aspect, an apparatus for associating a gateway control session with an Internet protocol connectivity access network (IP-CAN) session in a wireless network comprising means for receiving an access terminal (AT) IP address allocation; means for establishing the gateway control session after the IP address allocation is received; and means for associating the gateway control session with the IP-CAN session using the AT IP address allocation.

According to another aspect, an apparatus for associating a gateway control session with an Internet protocol connectivity access network (IP-CAN) session in a wireless network comprising means for receiving a correlation identifier in the gateway control session; means for receiving the correlation identifier in the IP-CAN session; and means for associating the gateway control session with the IP-CAN session using the correlation identifier.

According to another aspect, an apparatus for establishing a wireless connection comprising: means for establishing a point-to-point protocol (PPP) link between an access terminal (AT) and a wireless network; means for establishing an Internet Protocol (IP) connection using the PPP link; and means for using the IP connection for sending at least one of the following: a network access identifier (NAI) of the AT, access point name (APN) information, IP address allocation of the AT, or a correlation identifier.

According to another aspect, an apparatus for associating a gateway control session with an Internet protocol connectivity access network (IP-CAN) session in a wireless network, the apparatus comprising a processor and a memory, the memory containing program code executable by the processor for performing the following: receiving an IP address for a home agent/local mobility agent (HA/LMA); receiving a network access identifier (NAI) of an access terminal (AT); and associating the gateway control session with the Internet protocol connectivity access network (IP-CAN) session using the IP address and the NAI.

According to another aspect, an apparatus for associating a gateway control session with an Internet protocol connectivity access network (IP-CAN) session in a wireless network, the apparatus comprising a processor and a memory, the memory containing program code executable by the processor for performing the following: receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and associating the gateway control session with the Internet protocol connectivity access network (IP-CAN) session using the APN information.

According to another aspect, an apparatus for associating a gateway control session with an Internet protocol connectivity access network (IP-CAN) session in a wireless network, the apparatus comprising a processor and a memory, the memory containing program code executable by the processor for performing the following: receiving an access terminal (AT) IP address allocation; establishing the gateway control session after the IP address allocation is received; and associating the gateway control session with the IP-CAN session using the AT IP address allocation.

According to another aspect, an apparatus for associating a gateway control session with an Internet protocol connectivity access network (IP-CAN) session in a wireless network, the apparatus comprising a processor and a memory, the memory containing program code executable by the processor for performing the following: receiving a correlation identifier in the gateway control session; receiving the correlation identifier in the IP-CAN session; and associating the gateway control session with the IP-CAN session using the correlation identifier.

According to another aspect, an apparatus for establishing a wireless connection, the apparatus comprising a processor and a memory, the memory containing program code executable by the processor for performing the following: establishing a point-to-point protocol (PPP) link between an access terminal (AT) and a wireless network; establishing an Internet Protocol (IP) connection using the PPP link; and using the IP connection for sending at least one of the following: a network access identifier (NAI) of the AT, access point name (APN) information, IP address allocation of the AT, or a correlation identifier.

According to another aspect, a computer program product for associating a gateway control session with an Internet protocol connectivity access network (IP-CAN) session in a wireless network comprising a computer-readable medium comprising: codes for receiving an IP address for a home agent/local mobility agent (HA/LMA); codes for receiving a network access identifier (NAI) of an access terminal (AT); and codes for associating the gateway control session with the Internet protocol connectivity access network (IP-CAN) session using the IP address and the NAI.

According to another aspect, a computer program product for associating a gateway control session with an Internet protocol connectivity access network (IP-CAN) session in a wireless network comprising a computer-readable medium comprising: codes for receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and codes for associating the gateway control session with the Internet protocol connectivity access network (IP-CAN) session using the APN information.

According to another aspect, a computer program product for associating a gateway control session with an Internet protocol connectivity access network (IP-CAN) session in a wireless network comprising a computer-readable medium comprising: codes for receiving an access terminal (AT) IP address allocation; codes for establishing the gateway control session after the IP address allocation is received; and codes for associating the gateway control session with the IP-CAN session using the AT IP address allocation.

According to another aspect, a computer program product for associating a gateway control session with an Internet protocol connectivity access network (IP-CAN) session in a wireless network comprising a computer-readable medium comprising: codes for receiving a correlation identifier in the gateway control session; codes for receiving the correlation identifier in the IP-CAN session; and codes for associating the gateway control session with the IP-CAN session using the correlation identifier.

According to another aspect, a computer program product for establishing a wireless connection comprising a computer-readable medium comprising: codes for establishing a point-to-point protocol (PPP) link between an access terminal (AT) and a wireless network; codes for establishing an Internet Protocol (IP) connection using the PPP link; and codes for using the IP connection for sending at least one of the following: a network access identifier (NAI) of the AT, access point name (APN) information, IP address allocation of the AT, or a correlation identifier.

Advantages of the present disclosure may include the ability to allow association of a gateway control session and an IP-CAN session for wireless communication systems which do not directly convey an access point name (APN) to a policy charging and rules function (PCRF).

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram illustrating an example of a two terminal system.

FIG. 2 illustrates an example of a wireless communications system 290 that supports a plurality of user devices.

FIG. 3 illustrates an example of wireless Internet connectivity.

FIG. 4 illustrates an example of a first solution for associating a gateway control session with an Internet protocol connectivity access network (IP-CAN) session in a wireless network.

FIG. 5 illustrates an example of a second solution for associating a gateway control session with an Internet protocol connectivity access network (IP-CAN) session in a wireless network.

FIG. 6 illustrates an example of a third solution for associating a gateway control session with an Internet protocol connectivity access network (IP-CAN) session in a wireless network.

FIG. 7 illustrates an example of a fourth solution for associating a gateway control session with an Internet protocol connectivity access network (IP-CAN) session in a wireless network.

FIG. 8 illustrates an example of a device comprising a processor in communication with a memory for executing the processes for associating a gateway control session with an Internet protocol connectivity access network (IP-CAN) session in a wireless network.

FIG. 9 illustrates a first example of a device suitable for associating a gateway control session with an Internet protocol connectivity access network (IP-CAN) session in a wireless network.

FIG. 10 illustrates a second example of a device suitable for associating a gateway control session with an Internet protocol connectivity access network (IP-CAN) session in a wireless network.

FIG. 11 illustrates a third example of a device suitable for associating a gateway control session with an Internet protocol connectivity access network (IP-CAN) session in a wireless network.

FIG. 12 illustrates a fourth example of a device suitable for associating a gateway control session with an Internet protocol connectivity access network (IP-CAN) session in a wireless network.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Time Division Synchronous Code Division Multiple Access (TD-SCDMA) (a.k.a. Low Chip Rate (LCR)). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Tenn Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

In one example, wireless networks are compatible with various wireless protocols. Exemplary versions of wireless protocols include Universal Mobile Telecommunications System (UMTS), High Speed Downlink Packet Access (HSDPA), High Speed Uplink Packet Access (HSUPA), Long Tenn Evolution (LTE), code division multiple access (CDMA), etc. Wireless systems compliant with these protocols are used for various communication services such as telephony, messaging, data transfer, emails, Internet access, audio broadcasts, video communications, etc. These wireless systems generally utilize an access node (AN), also known as base station (BS), Node B or eNodeB, to connect to an individual access terminal (AT), also known as user equipment (UE) or user device, to fixed telecommunications infrastructure networks. In general, a radio coverage area is implemented using a plurality of Node Bs or eNodeBs using a cellular-based topological architecture to provide wireless access, also known as an air interface, to the UEs (e.g., user devices). Examples of fixed telecommunications infrastructure networks include the public switched telephony network (PSTN), Internet, private data networks, etc. In one aspect, the Node Bs or eNodeBs may be connected to a Radio Network Controller (RNC) to facilitate the interconnection to the fixed telecommunications infrastructure networks.

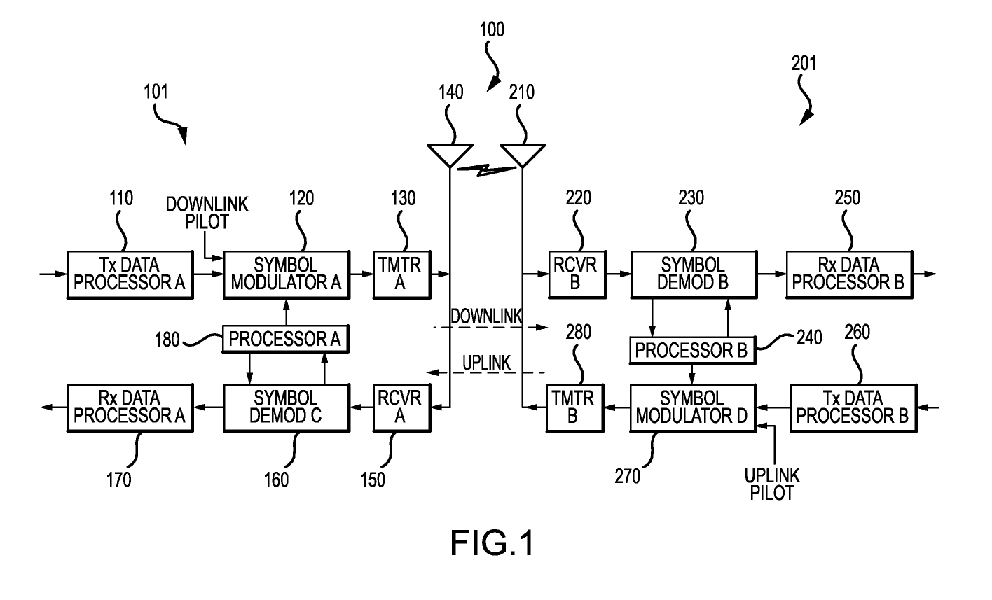

FIG. 1 is a block diagram illustrating an example of a two terminal system 100. One skilled in the art would understand that the example two terminal system 100 illustrated in FIG. 1 may be implemented in an FDMA environment, an OFDMA environment, a CDMA environment, a WCDMA environment, a TDMA environment, a SDMA environment or any other suitable wireless environment.

In one aspect, the two terminal system 100 includes an access node 101 (e.g., base station, Node B or eNodeB) and a user equipment or UE 201 (e.g., user device). In the downlink leg, the access node 101 (e.g., base station, Node B, eNodeB or access terminal) includes a transmit (TX) data processor A 110 that accepts, formats, codes, interleaves and modulates (or symbol maps) traffic data and provides modulation symbols (e.g., data symbols). The TX data processor A 110 is in communication with a symbol modulator A 120. The symbol modulator A 120 accepts and processes the data symbols and downlink pilot symbols and provides a stream of symbols. In one aspect, it is the symbol modulator A 120 that modulates (or symbol maps) traffic data and provides modulation symbols (e.g., data symbols). In one aspect, symbol modulator A 120 is in communication with processor A 180 which provides configuration information. Symbol modulator A 120 is in communication with a transmitter unit (TMTR) A 130. The symbol modulator A 120 multiplexes the data symbols and downlink pilot symbols and provides them to the transmitter unit A 130.

Each symbol to be transmitted may be a data symbol, a downlink pilot symbol or a signal value of zero. The downlink pilot symbols may be sent continuously in each symbol period. In one aspect, the downlink pilot symbols are frequency division multiplexed (FDM). In another aspect, the downlink pilot symbols are orthogonal frequency division multiplexed (OFDM). In yet another aspect, the downlink pilot symbols are code division multiplexed (CDM). In one aspect, the transmitter unit A 130 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 140.

In the downlink leg, the UE 201 (e.g., user device) includes antenna 210 for receiving the analog downlink signal and inputting the analog downlink signal to a receiver unit (RCVR) B 220. In one aspect, the receiver unit B 220 conditions, for example, filters, amplifies, and frequency downconverts the analog downlink signal to a first “conditioned” signal. The first “conditioned” signal is then sampled. The receiver unit B 220 is in communication with a symbol demodulator B 230. The symbol demodulator B 230 demodulates the first “conditioned” and “sampled” signal (e.g., data symbols) outputted from the receiver unit B 220. One skilled in the art would understand that an alternative is to implement the sampling process in the symbol demodulator B 230. The symbol demodulator B 230 is in communication with a processor B 240. Processor B 240 receives downlink pilot symbols from symbol demodulator B 230 and performs channel estimation on the downlink pilot symbols. In one aspect, the channel estimation is the process of characterizing the current propagation environment. The symbol demodulator B 230 receives a frequency response estimate for the downlink leg from processor B 240. The symbol demodulator B 230 performs data demodulation on the data symbols to obtain data symbol estimates on the downlink path. The data symbol estimates on the downlink path are estimates of the data symbols that were transmitted. The symbol demodulator B 230 is also in communication with a RX data processor B 250.

The RX data processor B 250 receives the data symbol estimates on the downlink path from the symbol demodulator B 230 and, for example, demodulates (i.e., symbol demaps), deinterleaves and/or decodes the data symbol estimates on the downlink path to recover the traffic data. In one aspect, the processing by the symbol demodulator B 230 and the RX data processor B 250 is complementary to the processing by the symbol modulator A 120 and TX data processor A 110, respectively.

In the uplink leg, the UE 201 (e.g., user device) includes a TX data processor B 260. The TX data processor B 260 accepts and processes traffic data to output data symbols. The TX data processor B 260 is in communication with a symbol modulator D 270. The symbol modulator D 270 accepts and multiplexes the data symbols with uplink pilot symbols, performs modulation and provides a stream of symbols. In one aspect, symbol modulator D 270 is in communication with processor B 240 which provides configuration information. The symbol modulator D 270 is in communication with a transmitter unit B 280.

Each symbol to be transmitted may be a data symbol, an uplink pilot symbol or a signal value of zero. The uplink pilot symbols may be sent continuously in each symbol period. In one aspect, the uplink pilot symbols are frequency division multiplexed (FDM). In another aspect, the uplink pilot symbols are orthogonal frequency division multiplexed (OFDM). In yet another aspect, the uplink pilot symbols are code division multiplexed (CDM). In one aspect, the transmitter unit B 280 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 210.

The analog uplink signal from UE 201 (e.g., user device) is received by antenna 140 and processed by a receiver unit A 150 to obtain samples. In one aspect, the receiver unit A 150 conditions, for example, filters, amplifies and frequency downconverts the analog uplink signal to a second “conditioned” signal. The second “conditioned” signal is then sampled. The receiver unit A 150 is in communication with a symbol demodulator C 160. One skilled in the art would understand that an alternative is to implement the sampling process in the symbol demodulator C 160. The symbol demodulator C 160 performs data demodulation on the data symbols to obtain data symbol estimates on the uplink path and then provides the uplink pilot symbols and the data symbol estimates on the uplink path to the RX data processor A 170. The data symbol estimates on the uplink path are estimates of the data symbols that were transmitted. The RX data processor A 170 processes the data symbol estimates on the uplink path to recover the traffic data transmitted by the wireless communication device 201. The symbol demodulator C 160 is also in communication with processor A 180. Processor A 180 performs channel estimation for each active terminal transmitting on the uplink leg. In one aspect, multiple terminals may transmit pilot symbols concurrently on the uplink leg on their respective assigned sets of pilot subbands where the pilot subband sets may be interlaced.

Processor A 180 and processor B 240 direct (i.e., control, coordinate or manage, etc.) operation at the access node 101 (e.g., base station, Node B or eNodeB) and at the UE 201 (e.g., user device), respectively. In one aspect, either or both processor A 180 and processor B 240 are associated with one or more memory units (not shown) for storing of program codes and/or data. In one aspect, either or both processor A 180 or processor B 240 or both perform computations to derive frequency and impulse response estimates for the uplink leg and downlink leg, respectively.

In one aspect, the two terminal system 100 is a multiple-access system. For a multiple-access system (e.g., frequency division multiple access (FDMA), orthogonal frequency division multiple access (OFDMA), code division multiple access (CDMA), time division multiple access (TDMA), space division multiple access (SDMA), etc.), multiple terminals transmit concurrently on the uplink leg, allowing access to a plurality of UEs (e.g., user devices). In one aspect, for the multiple-access system, the pilot subbands may be shared among different terminals. Channel estimation techniques are used in cases where the pilot subbands for each terminal span the entire operating band (possibly except for the band edges). Such a pilot subband structure is desirable to obtain frequency diversity for each terminal.

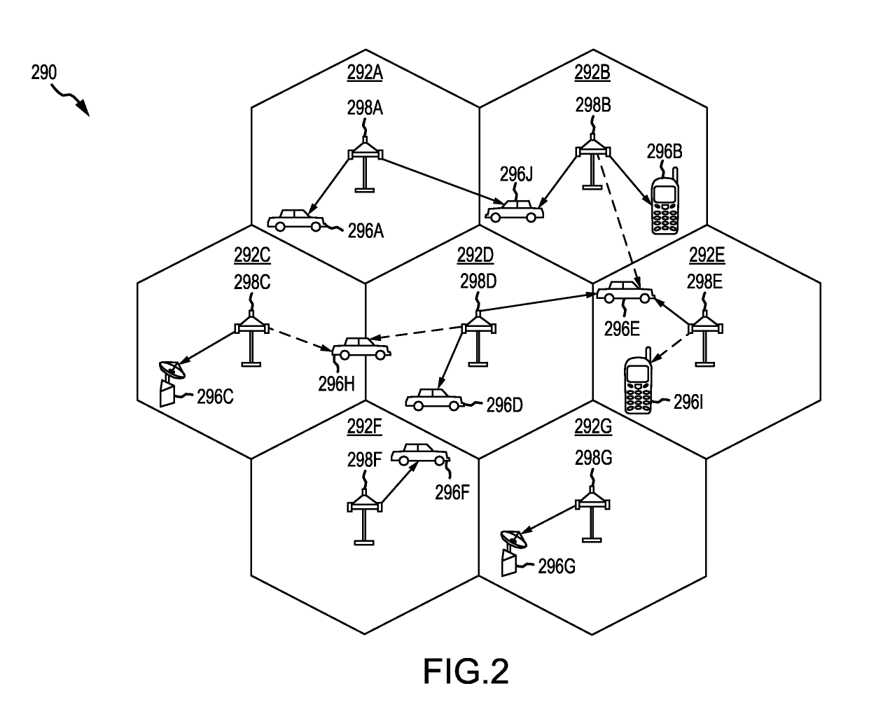

FIG. 2 illustrates an example of a wireless communications system 290 that supports a plurality of user devices. In FIG. 2, reference numerals 292A to 292G refer to cells, reference numerals 298A to 298G refer to base stations (BS), node Bs or eNodeBs and reference numerals 296A to 296J refer to access user devices (a.k.a. user equipments (UE)). Cell size may vary. Any of a variety of algorithms and methods may be used to schedule transmissions in system 290. System 290 provides communication for a number of cells 292A through 292G, each of which is serviced by a corresponding base station 298A through 298G, respectively.

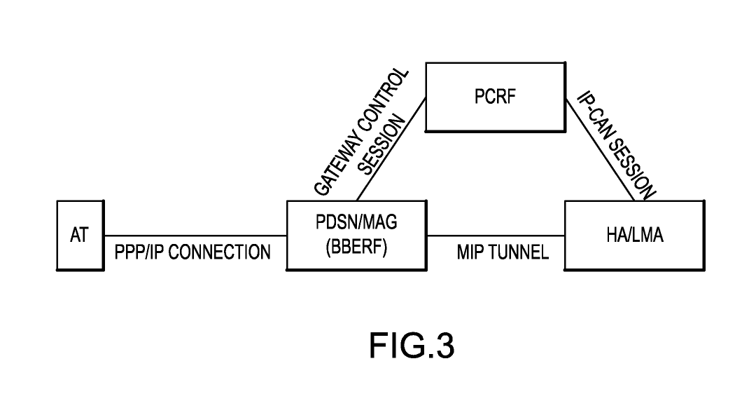

In one aspect, wireless communications systems provide access to the Internet to mobile users with an access terminal (AT) in a wireless network. FIG. 3 illustrates an example of wireless Internet connectivity. As shown, an AT is connected to a packet data serving node (PDSN) or mobility access gateway (MAG) which provides user access to network infrastructure. In one example, the connectivity between the AT and the PDSN uses a Point to Point Protocol with Internet Protocol (PPP/IP). In one aspect, the PDSN also serves as a bearer binding and event reporting function (BBERF) for the wireless network.

In one example, for the case of a policy control and charging (PCC) architecture using proxy mobile IP version 6 (PMIP6), a gateway control session is set up between the PDSN and a policy charging and rules function (PCRF). Also, for example, an Internet Protocol Connectivity Access Network (IP-CAN) session is set up between the PCRF and a home agent/local mobility agent (HA/LMA). In one example, the PCRF associates the gateway control session from the PDSN with the IP-CAN session from the HA/LMA. In one aspect, the PCRF associates the IP-CAN session with the gateway control session using identifiers such as UE identity (e.g. network access identifier (NAI)), packet data network (PDN) identifier (e.g. access point name (APN)). In another aspect, a proxy mobile IP (PMIP) tunnel may be set up between the PDSN/MAG (a.k.a. MAG/PDSN) and HA/LMA.

In one aspect, an IP-CAN provides IP connectivity within a wireless network to network infrastructure such as an IP multimedia subsystem (IMS). In another aspect, a PCRF is a network node which determines policy rules by aggregating information, creating rules, and making policy decisions.

In one example, for the case of high rate packet data (HRPD) wireless systems, the AT does not send the access point name (APN) in the signaling between the AT and the PDSN. In one aspect, the PCRF is not able to associate the gateway control session with the IP-CAN session.

For example, there are several solutions to the problem described above for associating a gateway control session with an IP-CAN session in a wireless network, such as HRPD. In a first solution, a Home Agent/LMA IP address and a NAI of an access terminal may be used for associating a gateway control session with an IP-CAN session. In a second solution, APN information may be added to an AT-PDSN signaling interface. In a third solution, an IP address of an AT in a gateway control/IP-CAN session may be used. In a fourth solution, unique correlation identifier generated at the PDSN may be used.

In one aspect, the first solution uses an IP address for a Home Agent/LMA and a NAI of an access terminal to associate a gateway control session with an IP-CAN session. In one example, both PDSN and HA send the IP address of the HA in a gateway control session/IP-CAN session in a specified common format. In one example, to avoid change to gateway control session signaling and IP-CAN session signaling, the HA/LMA IP address may be encoded in American Standard Code for Information Interchange (ASCII) format. A potential advantage of the first solution is that there is no impact to an existing AT-PDSN signaling interface.

In one aspect, the second solution adds APN information to an AT-PDSN signaling interface. The APN may be added as a new Vendor Specific Option of IP control protocol or IPv6 control protocol (IPCP/IPv6CP). IPCP may establish and configure IP over a PPP link. In one example, the APN may be added as a new configuration option in a Vendor Specific Network Control Protocol (VSNCP). In one example, VSNCP negotiates the use of a Vendor Specific Network Protocol (VSNP). In another example, the APN may be added in a dynamic host configuration protocol (DHCP) configuration. DHCP may be used for network device configuration. In one example, the newly added APN may be included in the PDN identifier field of the gateway control session and the IP-CAN session.

In another aspect, the third solution uses the IP address of an AT in a gateway control session/IP-CAN session. In one example, wait for an IP address allocation for the AT before the gateway control session is established. The allocated IP address is used for association. Limitations may include: the IP address may overlap across different HAs, and a change to current gateway control session establishment procedure may be required.

In another aspect, the fourth solution uses unique correlation identifier generated at a PDSN. In one example, a correlation identifier is passed from the PDSN to the HA/LMA. The correlation identifier may be passed with a new information element (IE) in a proxy binding update (PBU). In another example, the correlation identifier is also passed from the PDSN and the HA/LMA to the PCRF in the gateway control session and IP-CAN session respectively. If no protocol changes are desired, the correlation identifier may be passed using an attribute value pair (AVP) for carrying a PDN identifier.

All four solutions may be expanded for Client Mobile IP v4 (MIPv4) Foreign Agent Mode. For example, a combination of one or more solutions may be possible. For example, the first solution and the fourth solution may be combined to handle multiple PDN connections to the same HA/LMA case.

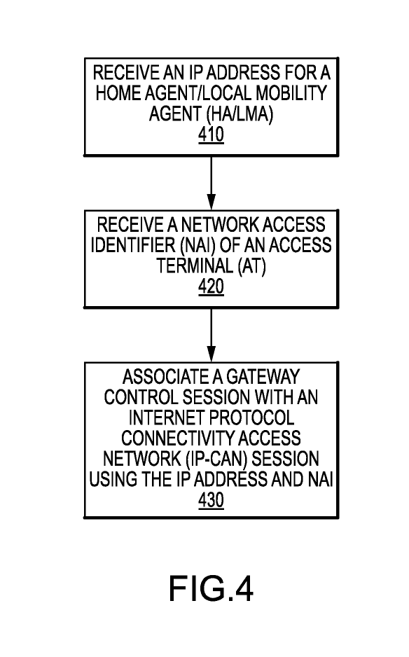

FIG. 4 illustrates an example of a first solution for associating a gateway control session with an Internet protocol connectivity access network (IP-CAN) session in a wireless network, such as a high rate packet data (HRPD) network. In block 410, receive an IP address for a home agent/local mobility agent (HA/LMA). In block 420, receive a network access identifier (NAI) of an access terminal (AT). In one example, the IP address and NAI are sent in a common specified format. In one example, the IP address and NAI are sent in ASCII format. In one example, both the IP address and NAI are received from a mobility access gateway/packet data serving node (MAG/PDSN) and an IP Anchor home agent/local mobility agent (HA/LMA). In block 430, associate the gateway control session with the Internet protocol connectivity access network (IP-CAN) session using the IP address and NAI. In one example, the steps in blocks 410-430 are performed by the policy charging and rules function (PCRF).

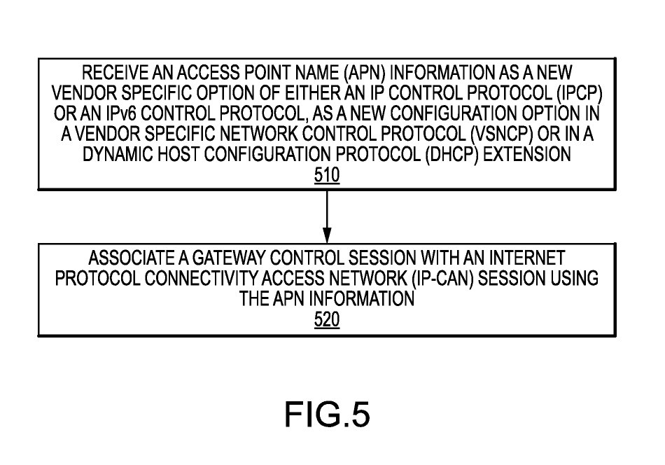

FIG. 5 illustrates an example of a second solution for associating a gateway control session with an Internet protocol connectivity access network (IP-CAN) session in a wireless network, such as a high rate packet data (HRPD) network. In block 510, receive an access point name (APN) information as a new Vendor Specific Option of either an IP control protocol (IPCP) or an IPv6 control protocol, as a new configuration option in a Vendor Specific Network Control Protocol (VSNCP) or in a dynamic host configuration protocol (DHCP) extension. In one aspect, the APN information is generated from an access terminal (AT) or a mobility access gateway/packet data serving node (MAG/PDSN). In one example the APN information is included in a gateway control session packet data network (PDN) identifier field. In another example, the APN information is included in an IP-CAN PDN identifier field. In block 520, associate the gateway control session with the Internet protocol connectivity access network (IP-CAN) session using the APN information. In one example, the steps in blocks 510-520 are performed by the policy charging and rules function (PCRF).

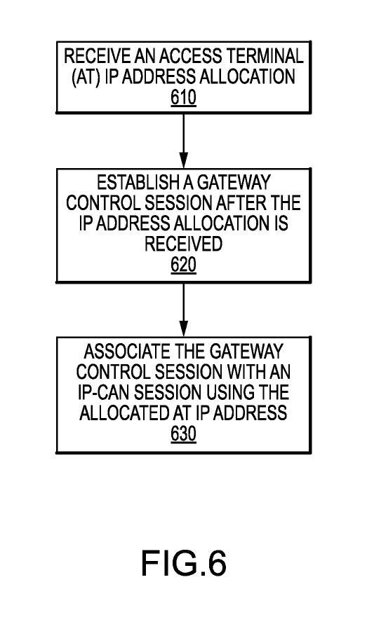

FIG. 6 illustrates an example of a third solution for associating a gateway control session with an Internet protocol connectivity access network (IP-CAN) session in a wireless network, such as a high rate packet data (HRPD) network. In block 610, receive an access terminal (AT) IP address allocation. In block 620, establish the gateway control session after the IP address allocation is received. In block 630, associate the gateway control session with the IP-CAN session using the allocated AT IP address. In one example, the steps in blocks 610-630 are performed by the policy charging and rules function (PCRF).

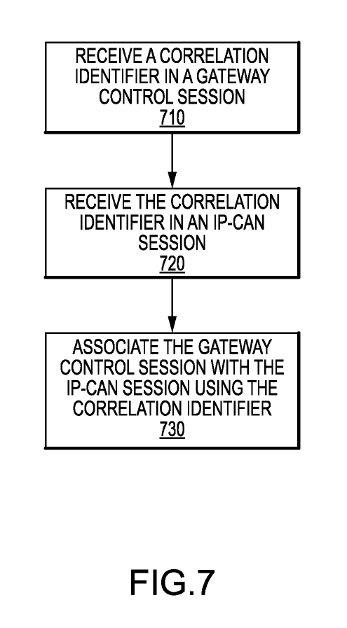

FIG. 7 illustrates an example of a fourth solution for associating a gateway control session with an Internet protocol connectivity access network (IP-CAN) session in a wireless network, such as a high rate packet data (HRPD) network. In block 710, receive a correlation identifier in the gateway control session. In block 720, receive the correlation identifier in the IP-CAN session. In one example the correlation identifier was received using an attribute value pair (AVP) for carrying the correlation identifier. In one example, the correlation identifier is a packet data network (PDN) identifier. In one example, the correlation identifier was received from a home agent/local mobility agent (HA/LMA). In one example, the correlation identifier includes a new information element (IE) in a proxy binding update (PBU). In block 730, associate the gateway control session with the IP-CAN session using the correlation identifier. In one example, the steps in blocks 710-730 are performed by the policy charging and rules function (PCRF).

In one aspect, establishing a wireless connection includes establishing a point-to-point protocol (PPP) link between an access terminal (AT) and a wireless network, establishing an Internet Protocol (IP) connection using the PPP link, and using the IP connection for sending at least one of the following: a network access identifier (NAI) of the AT, access point name (APN) information, IP address allocation of the AT, or a correlation identifier. In one example, the APN information is one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension. In one example, the wireless connection is established by the AT.

One skilled in the art would understand that the steps disclosed in the example flow diagrams in FIGS. 4-7 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

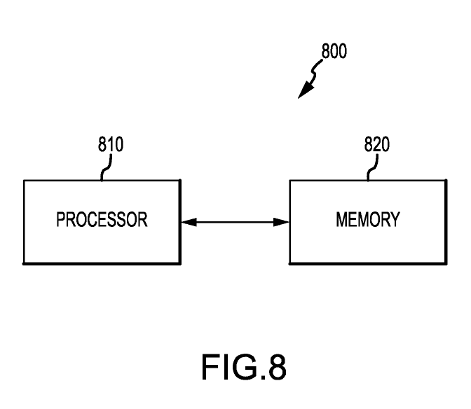

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 8 illustrates an example of a device 800 comprising a processor 810 in communication with a memory 820 for executing the processes for associating a gateway control session with an Internet protocol connectivity access network (IP-CAN) session in a wireless network. In one example, the device 800 is used to implement the algorithm illustrated in FIGS. 4-7. In one aspect, the memory 820 is located within the processor 810. In another aspect, the memory 820 is external to the processor 810. In one aspect, the processor includes circuitry for implementing or performing the various flow diagrams, logical blocks and/or modules described herein.

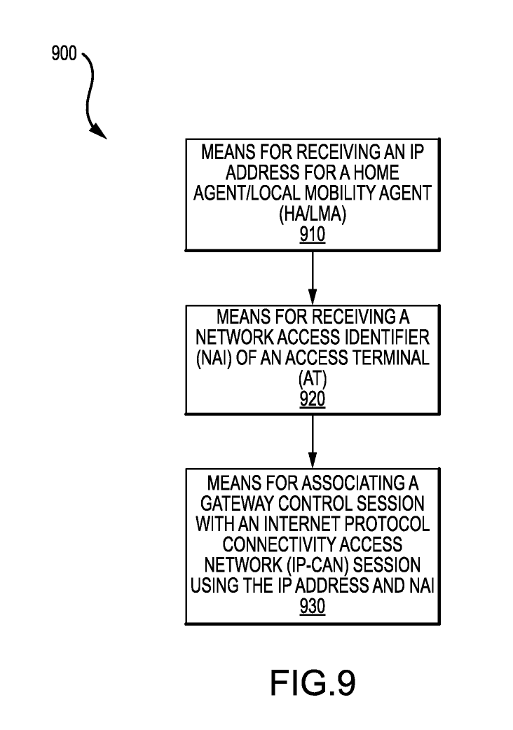

FIG. 9 illustrates a first example of a device 900 suitable for associating a gateway control session with an Internet protocol connectivity access network (IP-CAN) session in a wireless network. In one aspect, the device 900 is implemented by at least one processor comprising one or more modules configured to provide different aspects of associating a gateway control session with an Internet protocol connectivity access network (IP-CAN) session in a wireless network as described herein in blocks 910, 920 and 930. For example, each module comprises hardware, firmware, software, or any combination thereof. In one aspect, the device 900 is also implemented by at least one memory in communication with the at least one processor.

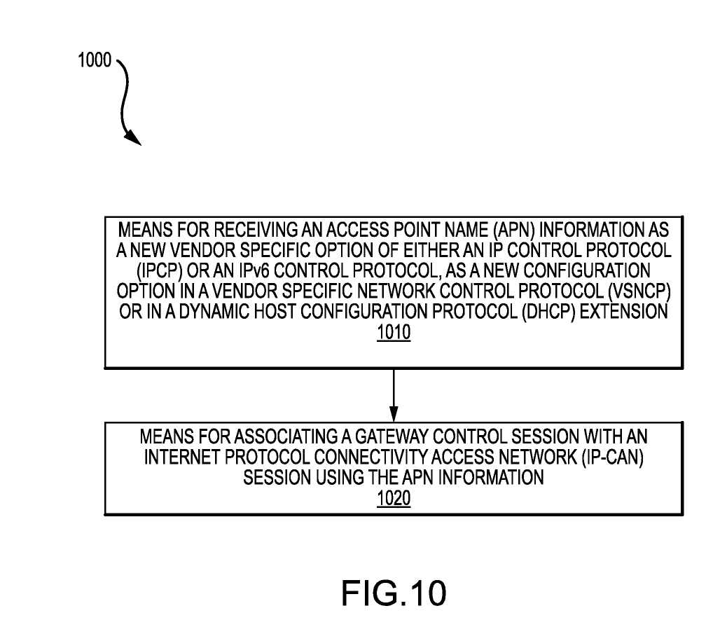

FIG. 10 illustrates a second example of a device 1000 suitable for associating a gateway control session with an Internet protocol connectivity access network (IP-CAN) session in a wireless network. In one aspect, the device 1000 is implemented by at least one processor comprising one or more modules configured to provide different aspects of for associating a gateway control session with an Internet protocol connectivity access network (IP-CAN) session in a wireless network as described herein in blocks 1010 and 1020. For example, each module comprises hardware, firmware, software, or any combination thereof. In one aspect, the device 1000 is also implemented by at least one memory in communication with the at least one processor.

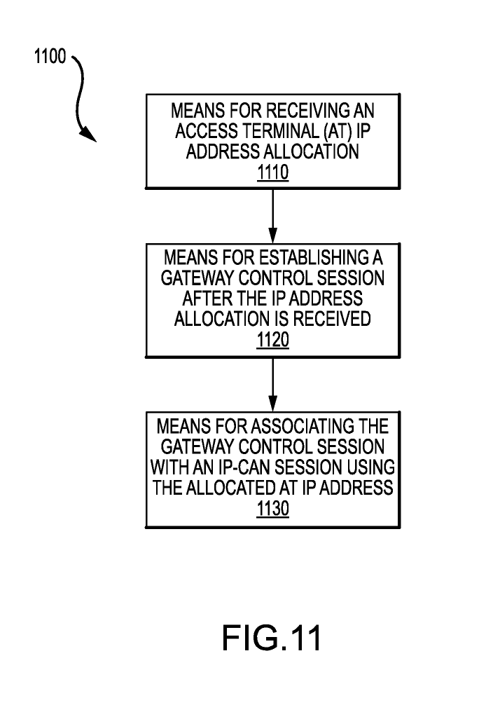

FIG. 11 illustrates a third example of a device 1100 suitable for associating a gateway control session with an Internet protocol connectivity access network (IP-CAN) session in a wireless network. In one aspect, the device 1100 is implemented by at least one processor comprising one or more modules configured to provide different aspects of for associating a gateway control session with an Internet protocol connectivity access network (IP-CAN) session in a wireless network as described herein in blocks 1110, 1120 and 1130. For example, each module comprises hardware, firmware, software, or any combination thereof. In one aspect, the device 1100 is also implemented by at least one memory in communication with the at least one processor.

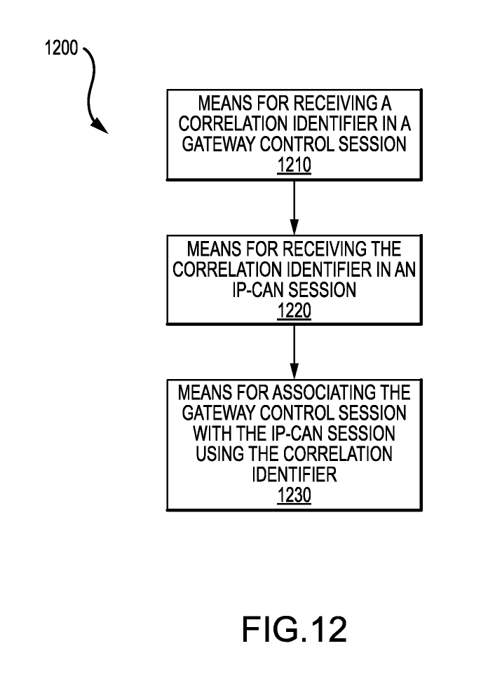

FIG. 12 illustrates a fourth example of a device 1200 suitable for associating a gateway control session with an Internet protocol connectivity access network (IP-CAN) session in a wireless network. In one aspect, the device 1200 is implemented by at least one processor comprising one or more modules configured to provide different aspects of for associating a gateway control session with an Internet protocol connectivity access network (IP-CAN) session in a wireless network as described herein in blocks 1210, 1220 and 1230. For example, each module comprises hardware, firmware, software, or any combination thereof. In one aspect, the device 1200 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for associating a gateway control session with an Internet protocol connectivity access network (IP-CAN) session in a wireless network comprising:
receiving an IP address for a home agent/local mobility agent (HA/LMA);
receiving a network access identifier (NAI) of an access terminal (AT); and
associating the gateway control session with the Internet protocol connectivity access network (IP-CAN) session using the IP address and the NAI.

2. The method of claim 1 wherein the steps are performed by a policy charging and rules function (PCRF).

3. The method of claim 2 wherein the IP address and the NAI are sent in a common specified format to the PCRF.

4. The method of claim 2 wherein the IP address and the NAI are sent in ASCII format to the PCRF.

5. The method of claim 1 wherein the wireless network is a high rate packet data (HRPD) network.

6. The method of claim 1 wherein both the IP address and NAI are received from a mobility access gateway/packet data serving node (MAG/PDSN) and an IP Anchor home agent/local mobility agent (HA/LMA).

7. A method for associating a gateway control session with an Internet protocol connectivity access network (IP-CAN) session in a wireless network comprising:
receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and
associating the gateway control session with the Internet protocol connectivity access network (IP-CAN) session using the APN information.

8. The method of claim 7 wherein the APN information is generated from an access terminal (AT) or a mobility access gateway/packet data serving node (MAG/PDSN).

9. The method of claim 7 wherein the APN information is included in a gateway control session packet data network (PDN) identifier field or in an IP-CAN PDN identifier field.

10. A method for associating a gateway control session with an Internet protocol connectivity access network (IP-CAN) session in a wireless network comprising:
receiving an access terminal (AT) IP address allocation;
establishing the gateway control session after the IP address allocation is received; and
associating the gateway control session with the IP-CAN session using the AT IP address allocation.

11. A method for associating a gateway control session with an Internet protocol connectivity access network (IP-CAN) session in a wireless network comprising:
receiving a correlation identifier in the gateway control session;
receiving the correlation identifier in the IP-CAN session; and
associating the gateway control session with the IP-CAN session using the correlation identifier.

12. The method of claim 11 wherein the correlation identifier is received from a mobility access gateway/packet data serving node (MAG/PDSN).

13. The method of claim 11 wherein the correlation identifier was received using an attribute value pair (AVP) for carrying the correlation identifier.

14. The method of claim 13 wherein the correlation identifier is a packet data network (PDN) identifier.

15. The method of claim 11 wherein the correlation identifier was received from a home agent/local mobility agent (HA/LMA).

16. The method of claim 11 wherein the correlation identifier includes a new information element (IE) in a proxy binding update (PBU).

17. A method for establishing a wireless connection comprising:
establishing a point-to-point protocol (PPP) link between an access terminal (AT) and a wireless network;
establishing an Internet Protocol (IP) connection using the PPP link; and
using the IP connection for sending at least one of the following: a network access identifier (NAI) of the AT, access point name (APN) information, IP address allocation of the AT, or a correlation identifier.

18. The method of claim 17 wherein the APN information is one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension.

19. An apparatus for associating a gateway control session with an Internet protocol connectivity access network (IP-CAN) session in a wireless network comprising:
means for receiving an IP address for a home agent/local mobility agent (HA/LMA);
means for receiving a network access identifier (NAI) of an access terminal (AT); and
means for associating the gateway control session with the Internet protocol connectivity access network (IP-CAN) session using the IP address and the NAI.

20. The apparatus of claim 19 wherein the apparatus is a policy charging and rules function (PCRF) in the wireless network.

21. The apparatus of claim 20 wherein the IP address and the NAI are sent in a common specified format to the PCRF.

22. The apparatus of claim 20 wherein the IP address and the NAI are sent in ASCII format to the PCRF.

23. The apparatus of claim 19 wherein the wireless network is a high rate packet data (HRPD) network.

24. The apparatus of claim 19 wherein both the IP address and NAI are received from a mobility access gateway/packet data serving node (MAG/PDSN) and an IP Anchor home agent/local mobility agent (HA/LMA).

25. An apparatus for associating a gateway control session with an Internet protocol connectivity access network (IP-CAN) session in a wireless network comprising:
means for receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and
means for associating the gateway control session with the Internet protocol connectivity access network (IP-CAN) session using the APN information.

26. The apparatus of claim 25 wherein the APN information is generated from an access terminal (AT) or a mobility access gateway/packet data serving node (MAG/PDSN).

27. The apparatus of claim 25 wherein the APN information is included in a gateway control session packet data network (PDN) identifier field or in an IP-CAN PDN identifier field.

28. An apparatus for associating a gateway control session with an Internet protocol connectivity access network (IP-CAN) session in a wireless network comprising:
means for receiving an access terminal (AT) IP address allocation;
means for establishing the gateway control session after the IP address allocation is received; and
means for associating the gateway control session with the IP-CAN session using the AT IP address allocation.

29. An apparatus for associating a gateway control session with an Internet protocol connectivity access network (IP-CAN) session in a wireless network comprising:
means for receiving a correlation identifier in the gateway control session;
means for receiving the correlation identifier in the IP-CAN session; and
means for associating the gateway control session with the IP-CAN session using the correlation identifier.

30. The apparatus of claim 29 wherein the correlation identifier is received from a mobility access gateway/packet data serving node (MAG/PDSN).

31. The apparatus of claim 29 wherein the correlation identifier was received using an attribute value pair (AVP) for carrying the correlation identifier.

32. The apparatus of claim 31 wherein the correlation identifier is a packet data network (PDN) identifier.

33. The apparatus of claim 29 wherein the correlation identifier was received from a home agent/local mobility agent (HA/LMA).

34. The apparatus of claim 29 wherein the correlation identifier includes a new information element (IE) in a proxy binding update (PBU).

35. An apparatus for establishing a wireless connection comprising:
means for establishing a point-to-point protocol (PPP) link between an access terminal (AT) and a wireless network;
means for establishing an Internet Protocol (IP) connection using the PPP link; and
means for using the IP connection for sending at least one of the following: a network access identifier (NAI) of the AT, access point name (APN) information, IP address allocation of the AT, or a correlation identifier.

36. The apparatus of claim 35 wherein the APN information is one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension.

37. An apparatus for associating a gateway control session with an Internet protocol connectivity access network (IP-CAN) session in a wireless network, the apparatus comprising a processor and a memory, the memory containing program code executable by the processor for performing the following:
receiving an IP address for a home agent/local mobility agent (HA/LMA);
receiving a network access identifier (NAI) of an access terminal (AT); and
associating the gateway control session with the Internet protocol connectivity access network (IP-CAN) session using the IP address and the NAI.

38. The apparatus of claim 37 is a policy charging and rules function (PCRF) in the wireless network.

39. The apparatus of claim 38 wherein the IP address and the NAI are sent in a common specified format to the PCRF.

40. The apparatus of claim 38 wherein the IP address and the NAI are sent in ASCII format to the PCRF.

41. The apparatus of claim 37 wherein the wireless network is a high rate packet data (HRPD) network.

42. The apparatus of claim 37 wherein both the IP address and NAI are received from a mobility access gateway/packet data serving node (MAG/PDSN) and an IP Anchor home agent/local mobility agent (HA/LMA).

43. An apparatus for associating a gateway control session with an Internet protocol connectivity access network (IP-CAN) session in a wireless network, the apparatus comprising a processor and a memory, the memory containing program code executable by the processor for performing the following:
receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and
associating the gateway control session with the Internet protocol connectivity access network (IP-CAN) session using the APN information.

44. The apparatus of claim 43 wherein the APN information is generated from an access terminal (AT) or a mobility access gateway/packet data serving node (MAG/PDSN).

45. The apparatus of claim 43 wherein the APN information is included in a gateway control session packet data network (PDN) identifier field or in an IP-CAN PDN identifier field.

46. An apparatus for associating a gateway control session with an Internet protocol connectivity access network (IP-CAN) session in a wireless network, the apparatus comprising a processor and a memory, the memory containing program code executable by the processor for performing the following:
receiving an access terminal (AT) IP address allocation;
establishing the gateway control session after the IP address allocation is received; and
associating the gateway control session with the IP-CAN session using the AT IP address allocation.

47. An apparatus for associating a gateway control session with an Internet protocol connectivity access network (IP-CAN) session in a wireless network, the apparatus comprising a processor and a memory, the memory containing program code executable by the processor for performing the following:
receiving a correlation identifier in the gateway control session;
receiving the correlation identifier in the IP-CAN session; and
associating the gateway control session with the IP-CAN session using the correlation identifier.

48. The apparatus of claim 47 wherein the correlation identifier is received from a mobility access gateway/packet data serving node (MAG/PDSN).

49. The apparatus of claim 47 wherein the correlation identifier was received using an attribute value pair (AVP) for carrying the correlation identifier.

50. The apparatus of claim 49 wherein the correlation identifier is a packet data network (PDN) identifier.

51. The apparatus of claim 47 wherein the correlation identifier was received from a home agent/local mobility agent (HA/LMA).

52. The apparatus of claim 47 wherein the correlation identifier includes a new information element (IE) in a proxy binding update (PBU).

53. An apparatus for establishing a wireless connection, the apparatus comprising a processor and a memory, the memory containing program code executable by the processor for performing the following:
establishing a point-to-point protocol (PPP) link between an access terminal (AT) and a wireless network;
establishing an Internet Protocol (IP) connection using the PPP link; and
using the IP connection for sending at least one of the following: a network access identifier (NAI) of the AT, access point name (APN) information, IP address allocation of the AT, or a correlation identifier.

54. The apparatus of claim 53 wherein the APN information is one of the following:
a new Vendor Specific Option of either an IP control protocol (IPCP) or an IPv6 control protocol, a new configuration option in a Vendor Specific Network Control Protocol (VSNCP), or a dynamic host configuration protocol (DHCP) extension.

55. A computer program product for associating a gateway control session with an Internet protocol connectivity access network (IP-CAN) session in a wireless network comprising:
a computer-readable medium comprising:
codes for receiving an IP address for a home agent/local mobility agent (HA/LMA);
codes for receiving a network access identifier (NAI) of an access terminal (AT); and
codes for associating the gateway control session with the Internet protocol connectivity access network (IP-CAN) session using the IP address and the NAI.

56. A computer program product for associating a gateway control session with an Internet protocol connectivity access network (IP-CAN) session in a wireless network comprising:
a computer-readable medium comprising:
codes for receiving an access point name (APN) information as one of the following: a new Vendor Specific Option of either an IP control protocol (IPCP) or an IPv6 control protocol, a new configuration option in a Vendor Specific Network Control Protocol (VSNCP), or a dynamic host configuration protocol (DHCP) extension; and
codes for associating the gateway control session with the Internet protocol connectivity access network (IP-CAN) session using the APN information.

57. A computer program product for associating a gateway control session with an Internet protocol connectivity access network (IP-CAN) session in a wireless network comprising:
a computer-readable medium comprising:
codes for receiving an access terminal (AT) IP address allocation;
codes for establishing the gateway control session after the IP address allocation is received; and
codes for associating the gateway control session with the IP-CAN session using the AT IP address allocation.

58. A computer program product for associating a gateway control session with an Internet protocol connectivity access network (IP-CAN) session in a wireless network comprising:
a computer-readable medium comprising:
codes for receiving a correlation identifier in the gateway control session;
codes for receiving the correlation identifier in the IP-CAN session; and
codes for associating the gateway control session with the IP-CAN session using the correlation identifier.

59. A computer program product for establishing a wireless connection comprising:
a computer-readable medium comprising:
codes for establishing a point-to-point protocol (PPP) link between an access terminal (AT) and a wireless network;
codes for establishing an Internet Protocol (IP) connection using the PPP link; and
codes for using the IP connection for sending at least one of the following: a network access identifier (NAI) of the AT, access point name (APN) information, IP address allocation of the AT, or a correlation identifier.
